(19) United States
(12) Patent Application Publication
(10) Pub. No.: US 2024/0199335 A1
(43) Pub. Date: Jun. 20, 2024

(54) DEVICE AND METHOD FOR COMMISSIONING

(71) Applicant: Winkel GmbH, Illingen (DE)

(72) Inventors: Athanasios LOUPAS, Mühlacker (DE); Alexander WEISSER, Pforzheim (DE)

(21) Appl. No.: 18/544,931

(22) Filed: Dec. 19, 2023

(30) Foreign Application Priority Data
Dec. 19, 2022 (DE) 10 2022 213 844.9

(51) Int. Cl. B65G 1/137; G06Q 10/087

(52) U.S. Cl. CPC B65G 1/1378; G06Q 10/087; B65G 2201/0267

(57) ABSTRACT

A device for picking/commissioning on pallets or goods carriers has a picking chute, and a temporary pallet store for unladen pallets. The temporary pallet store is arranged laterally next to the picking chute. The device also includes a feed device for transporting an unladen pallet from the picking chute to the temporary pallet store or from the temporary pallet store to the picking chute, and the temporary pallet store has at least two storage locations for pallets of different sizes.

### CROSS-REFERENCE TO RELATED APPLICATION

This claims priority from German Application No. 10 2022 213 844.9, filed Dec. 19, 2022, the disclosure of which is hereby incorporated by reference in its entirety.

### TECHNICAL FIELD

The invention relates to a device for picking/commissioning on pallets or goods carriers, having a picking chute, having a temporary pallet store for unladen pallets, wherein the temporary pallet store is arranged laterally next to the picking chute, and having a feed device for transporting an unladen pallet from the picking chute to the temporary pallet store or from the temporary pallet store to the picking chute. The invention also relates to a picking method.

### BACKGROUND AND SUMMARY

The aim of the invention is to improve a device and method for picking on pallets or goods carriers in terms of the flexibility of their use.

According to the invention, a device for picking on pallets or goods carriers is provided for this purpose. In addition, a method for picking on pallets or goods carriers is provided.

A device according to one aspect of the invention for picking on pallets or goods carriers has a picking chute, a temporary pallet store for unladen pallets, wherein the temporary pallet store is arranged laterally next to the picking chute, and a feed device for transporting an unladen pallet from the picking chute to the temporary pallet store or from the temporary pallet store to the picking chute. The temporary pallet store has at least two storage locations for pallets or goods carriers of different sizes. This means that pallets or goods carriers of different sizes can be loaded selectively and in direct succession by the picking device. This is because the temporary pallet store is used to temporarily store an unladen pallet outside the picking chute in order to arrange said pallet at the level of the picking plane again immediately after a fully loaded pallet has been lowered in the picking chute. This can happen while the fully loaded pallet is still being lowered in the picking chute or, for example, strapped or wrapped with stretch film. Since the temporary pallet store has at least two storage locations for pallets of different sizes, pallets of different sizes can be loaded alternately and in direct succession without any set-up times. The picking device according to the invention can thus be used in an extremely flexible manner.

In a development of the invention, the at least two storage locations in the temporary pallet store are arranged one above the other in the vertical direction of the picking chute.

In this way, it is possible to insert the different pallets into the picking chute without delay and without relocating or rearranging pallets in the temporary pallet store. This enables short cycle times to be achieved.

In a development of the invention, a lifting and lowering device is provided in order to move an unladen pallet up to the level of the temporary pallet store.

This allows an unladen pallet to be deposited in a storage location for the temporary pallet store while a pallet is being loaded.

In a development of the invention, the picking chute has at least one first adjustable chute wall, wherein by means of the first adjustable chute wall a free cross section of the picking chute can be changed at least in sections by means of a movement of the first adjustable chute wall perpendicular to the vertical direction of the picking chute, wherein the first adjustable chute wall has an upper section and a lower section in the vertical direction of the picking chute (22), wherein the upper section extends from a vertical position of the temporary pallet store to a picking plane at the upper end of the picking chute, wherein the lower section extends downwards starting from the vertical position of the temporary pallet store, and wherein the upper section and the lower section can be adjusted independently of each other.

By means of the first adjustable chute wall, the free cross section of the picking chute can be adjusted such that the walls of the picking chute are arranged only at a very small distance from the side edges of the pallet that is currently being loaded. This prevents load goods that are positioned on the pallet from falling into the picking chute laterally next to the pallet. This is extremely advantageous when picking is intended to be performed on pallets of different sizes. This is because a picker and/or a picking robot thus do/does not have to take extreme care to position the load goods exactly at the edge of the pallet.

By way of the first adjustable chute wall having an upper section and a lower section which can be adjusted independently of each other, it is possible to simultaneously load a first pallet of a first size with load goods and to insert a second pallet of a different size into the picking chute from below and then position it in the temporary pallet store. The pallet to be inserted into the temporary pallet store is not loaded, and therefore there is no risk of load goods falling off the pallet here. However, if, for example, a first pallet of small size is loaded, an unladen pallet of small size is generally always inserted into the temporary pallet store, so that two pallets of different sizes are always arranged in the temporary pallet store. A picker or master computer then always has the choice of whether a large or small pallet should be loaded next. Even if this selection is made only when the previous pallet is loaded, no waiting times are caused with the device according to the invention. When a first pallet of relatively small size is loaded, the upper section and the lower section of the first adjustable chute wall, when the pallet is loaded and then gradually lowered, can be arranged directly adjacent to the load goods on the pallet in order to prevent load goods on the pallet slipping or falling off during the gradual lowering operation.

In a development of the invention, the upper section of the adjustable chute wall is connected to a section of the picking plane.

In this way, an edge between the horizontally arranged picking plane and the vertically arranged first adjustable chute wall is also moved when the first chute wall is adjusted. As a result, an edge or a stop is always available for a picker or a picking robot in the region of the first adjustable chute wall in order to arrange load goods quickly and accurately on the pallet to be loaded or on already stacked load goods.

In a development of the invention, a second chute wall, which can be adjusted at least in sections, is provided, wherein the second adjustable chute wall is arranged perpendicular to the first adjustable chute wall and wherein by means of the second adjustable chute wall a free cross section of the picking chute can be changed at least in sections by means of a movement of the second adjustable chute wall perpendicular to the vertical direction of the picking chute.

By means of a second adjustable chute wall which is arranged perpendicular to the first adjustable chute wall, it is possible to process pallets of different sizes, in which both transverse dimensions are different. Even in a case of this kind, it is then possible to ensure that the walls of the picking chute are arranged directly adjacent to the edges of the loading surface of the pallet, so that load goods cannot slip off the pallet and fall into the picking chute.

In a development of the invention, a third chute wall, which can be adjusted at least in sections, is provided, wherein the third adjustable chute wall is arranged perpendicular to the first adjustable chute wall and wherein by means of the third adjustable chute wall a free cross section of the picking chute can be changed at least in sections by means of a movement of the third adjustable chute wall perpendicular to the vertical direction of the picking chute.

When picking on pallets of different sizes, different cases have to be considered: if the different pallets have the same transverse dimensions, an adjustable chute wall is sufficient to adjust the free cross section of the picking chute to the size of the pallet currently loaded. If, on the other hand, no transverse dimension is identical for the different pallets, it may be the case that it is advantageous for processing the two pallets of different sizes to adjust three chute walls of the picking chute. This may be the case, for example, when the pallets are intended to be arranged with their centre of gravity always central in relation to the free cross section of the picking chute or even when feet of the pallets are positioned such that the distance from the feet of the different pallets to the chute walls of the picking chute changes between different pallets. By means of a first, second and third adjustable chute wall, it is then possible to ensure that all four chute walls of the picking chute are arranged directly adjacent to the edges of the loading surface of the pallet.

In a development of the invention, means for holding and moving a pallet are provided in the upper section of the picking chute between a vertical position of the temporary pallet store and an upper end of the picking chute, wherein the holding and moving means are designed and arranged to take an unladen pallet from the temporary pallet store using the feed device, to move the unladen pallet to the upper end of the picking chute and, during a start of the loading process, to gradually lower the pallet until the pallet is transferred from the holding and moving means to a lifting and lowering device, wherein the holding and moving means have several pallet supports, which can be moved into a free cross section of the picking chute and out of the free cross section, and wherein the pallet supports can be moved into the free cross section of the picking chute and out again below a standing surface for a picker or a picking robot.

By means of such holding and moving means, an unladen pallet can be moved from the vertical position of the temporary pallet store to the upper end of the picking chute, that is to say until the loading surface of the pallet is arranged approximately at the level of or just below the picking plane. These holding and moving means are independent of a lifting and lowering device which takes unladen pallets from a feeding conveyor system, moves them into the picking chute from below and then transfers them to the feed device of the temporary pallet store. The lifting and lowering device also takes partially loaded pallets from the holding and moving means in order to either gradually lower them during further loading or to move fully laden pallets downwards in the picking chute in order to then be able to, for example, strap these fully loaded pallets or wrap them with stretch film. The lifting and lowering device is further intended to then transfer the fully loaded and completed pallets back to a discharging conveyor system. The interaction between the lifting and lowering device on the one hand and the holding and moving means on the other renders it possible, even while transporting a fully loaded pallet away or strapping or wrapping a fully loaded pallet, to take an unladen pallet from the temporary pallet store and arrange it level with or just below the level of the picking plane in order to be able to continue picking without losing time. By way of the holding and moving means having several pallet supports, which can be moved into a free cross section of the picking chute and out of the free cross section, wherein the pallet supports can be moved into the free cross section of the picking chute and out again, for example three walls of the picking chute can be designed to be very narrow in the transverse direction, below a standing surface for a picker or a picking robot. The inner sides of these walls form the chute walls of the picking chute. This allows very good ergonomics since a picker can stand very close to the pallet to be loaded and in particular does not have to bend over a very wide wall of the picking chute in order to move load goods onto the loading surface of the pallet. As a result, the pallet supports are moved into the free cross section of the picking chute below a standing surface of the picking platform and are also moved out of the free cross section of the picking chute again below the standing surface of the picking platform. Above the standing surface of the picking platform, the pallet supports are always arranged such that they project into the free cross section of the picking chute, and can therefore be moved only in the vertical direction, that is to say in the direction of the picking plane and away from the picking plane again, above the standing surface of the picking platform. The pallet supports can be pivoted, for example, into the free cross section of the picking chute and then moved upwards by means of a suitable height adjustment and moved downwards again. Below the standing surface of the picking platform, there is enough space available to move the pallet supports out of the free cross section of the picking chute in a simple manner, for example to pivot them out or else to move them out by means of a displacement movement or along a curved path.

In a development of the invention, the pallet supports can be moved only in and counter to the vertical direction of the picking chute above the standing surface for a picker or a picking robot.

The problem on which the invention is based is also solved by a method for picking on pallets or goods carriers with a device according to the invention.

In the method according to the invention, provision is made, amongst other things, for a further unladen pallet to be introduced into the picking chute from below while a pallet is being loaded, and then moved into one of the storage locations of the temporary pallet store by means of the feed device. Depending on which pallet size is intended to be loaded next, a pallet of this size is introduced into the picking chute by means of the feed device from one of the storage locations of the temporary pallet store and moved upwards up to the picking plane by the holding and moving means. While the pallet is being loaded, the pallet is then gradually lowered by the holding and moving means, according to the level of the load goods already stacked on the pallet. In the method according to the invention, the chute walls of the picking chute are then adjusted depending on the size of the pallet to be loaded and depending on the size of the unladen pallet to be introduced into the temporary store. Here, a first adjustable chute wall of the picking chute is adjusted in an upper section and a lower section of the first adjustable chute wall independently of each other. As a result, for example, a small pallet can already be loaded and a large pallet can be lowered downwards through the picking chute. The unladen pallets are expediently deposited in the temporary pallet store one above the other, so that pallets of different sizes can be moved directly into the picking chute from their respective storage location without having to be resorted or rearranged in the temporary pallet store.

In the method according to the invention, pallet supports of the holding and moving means are pivoted into the free cross section of the picking chute below a standing surface for a picker or picking robot on the picking platform and then, for moving an unladen pallet upwards up to the picking plane and subsequently during gradual lowering of a pallet, moved only in the vertical direction or counter to the vertical direction of the picking chute. As a result, at least one wall, if necessary also several walls, of the picking chute, can be of narrow design when viewed transversely to the vertical direction, so that very good ergonomics are provided for a picker. On account of at least one boundary wall of the picking chute being of very narrow design, the picker does not have to bend far over this wall, but rather can move load goods onto the pallet with a short and fast movement close to the body.

### BRIEF DESCRIPTION OF THE DRAWINGS

Further features and advantages of the invention can be found in the following description of a preferred embodiment of the invention in connection with the drawings. In the drawings:

FIG. 1 shows a schematic illustration of a picking device according to the invention in a first state,

FIG. 2 shows the device of FIG. 1 in a second state,

FIG. 3 shows the device of FIG. 1 in a third state,

FIG. 4 shows the device of FIG. 1 in a fourth state,

FIG. 5 shows the device of FIG. 1 in a fifth state,

FIG. 6 shows the device of FIG. 1 in a sixth state,

FIG. 7 shows the device of FIG. 1 in a seventh state,

FIG. 8 shows the device of FIG. 1 in an eighth state,

FIG. 9 shows a second embodiment of the device of FIG. 1 in the first state,

FIG. 10 shows a schematic plan view of the device of FIG. 1,

FIG. 11 shows a further schematic plan view of the device of FIG. 1,

FIG. 12 shows a schematic sectional view of the device of FIG. 1, where the sectional plane is arranged parallel to the vertical direction of the picking chute, and

FIG. 13 shows a further schematic sectional view of the device of FIG. 1, where the sectional plane is arranged parallel to the vertical direction of the picking chute, but perpendicular to the sectional plane of FIG. 12.

### DETAILED DESCRIPTION

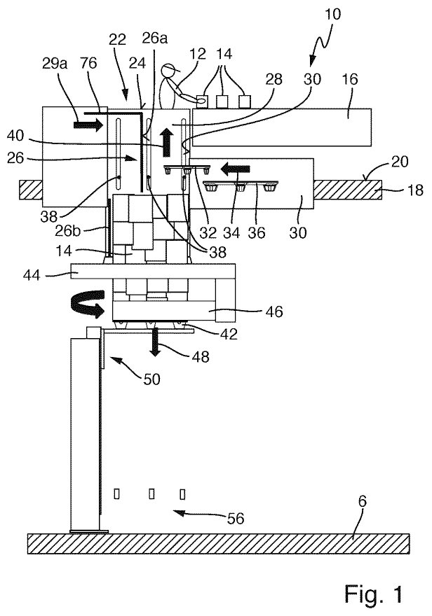

FIG. 1 shows a picking device 10 according to the invention. The device 10 is designed as a manual picking station and one or more pickers 12 move load goods 14, which are delivered by means of a merely schematically illustrated conveyor system 16, onto an initially unladen pallet. The device 10 stands on a hall floor 6, on which the conveyor system 56 is also arranged.

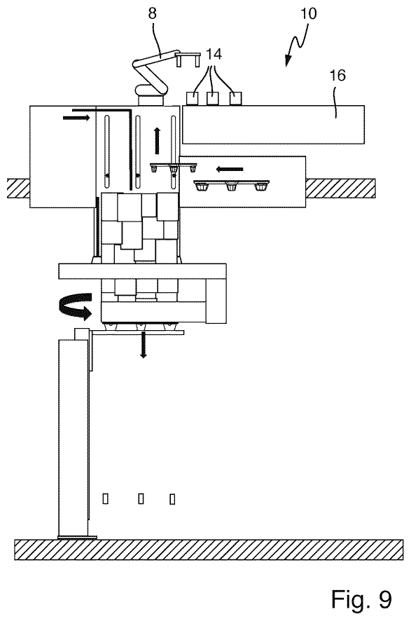

In contrast to FIG. 1, FIG. 9 shows an automatic picking station. In the embodiment as an automatic picking station according to FIG. 9, the device 10 has a picking robot 8, which, like the picker 12 in the case of a manual picking station, takes load goods 14 from the conveyor system 16 and moves them onto an initially unladen pallet.

Otherwise, the device 10 of FIG. 1 designed as a manual picking station and the device 10 of FIG. 9 designed as an automatic picking station are, however, of identical construction. In the context of the invention, it is possible to design the device 10 for mixed operation, in the case of which both a picker 12 and a picking robot 8 are provided in order to jointly load an initially unladen pallet with load goods 14.

The device 10 of FIG. 1 has a picking platform 18, the top side 20 of which forms a standing surface for one or two pickers 12. A picking chute 22 extends through the picking platform 18. An upper end of the picking chute 22 forms part of a picking plane 24.

FIG. 1 is a schematic illustration which allows a view into the picking chute 22 from the side. For this reason, only three chute walls of the picking chute 22 can be seen, specifically a first adjustable chute wall 26, a second adjustable chute wall 28 and a third, fixedly arranged chute wall 30. A third adjustable chute wall is arranged opposite and parallel to the second adjustable chute wall 28 but, as explained, is not shown in FIG. 1.

The first adjustable chute wall 26 has an upper section 26a and a lower section 26b. In the state of FIG. 1, the upper section 26a and the lower section 26b have been adjusted in different ways. This will be explained further below. Both the upper section 26a and the lower section 26b of the first adjustable chute wall 26 can be adjusted in and counter to an arrow 28, that is to say perpendicular to a vertical direction of the picking chute 22.

A temporary pallet store 30, which is likewise only schematically shown in FIG. 1, is provided level with the picking platform 18, but has two storage locations for pallets of different sizes. These two storage locations are arranged one above the other in the embodiment of FIG. 1. In the state of FIG. 1, a first, relatively small pallet 32 has been partially moved into the free cross section of the picking chute 22 by means of a feed device, not illustrated, in the horizontal direction straight from an upper storage location of the temporary pallet store 30. A second, relatively large pallet 36 is arranged in a second, lower storage location of the temporary pallet store 30.

The first pallet 32 is still empty and therefore not loaded. The second pallet 36 is likewise empty and not loaded. The two storage locations of the temporary pallet store 30 are intended only for unladen, empty pallets 32, 36.

The first, relatively small pallet 32 is already partially located in the free cross section of the picking chute 22. If the pallet 32 has been moved completely into the free cross section of the picking chute 22 by means of the feeding device, it is taken from there by holding and moving means 38 and can then be moved upwards up to the picking plane 24 in the vertical direction of the picking chute 22 in accordance with arrow 40. The first pallet 32 is moved upwards by means of the holding and moving means 38 until a top side of the first pallet 32 is arranged at the level of the picking plane 24 or just below the picking plane 24. During the process of loading the first pallet 32, the holding and moving means 38 move the pallet 32 gradually downwards according to their loading state, that is to say counter to the arrow 40. The picker 12 can thus always arrange load goods 14 approximately level with the picking plane 24.

In the state of FIG. 1, a third pallet 42 is already fully loaded and is arranged below the vertical position of the temporary pallet store 30. The third pallet 42 is already arranged below the lower end of the picking chute 22, wherein this lower end of the picking chute 22 is defined by a wrapping device 44. In the wrapping device 44, the fully loaded pallet 42 is wrapped directly with stretch film 46. During this wrapping process, the fully or partially loaded pallet 42 is lowered downwards in accordance with arrow 48. This is done by means of a lifting and lowering device 50. Load goods 14 are stacked in several layers on the third pallet 42. While the lowermost stack of load goods 14, which rests directly on the loading surface of the third pallet 42, is wrapped directly by means of stretch film 46, the upper layers with load goods 14 are still situated within the lower section 26b of the picking chute 22. This ensures that the load 14 cannot fall off the third pallet 42.

It can be seen in FIG. 1 that the lower section 26b of the first adjustable chute wall 26 is arranged directly adjacent to the upper layers of load goods 14 on the third pallet 42. The upper section 26a of the first adjustable chute wall 26, on the other hand, has been moved slightly into the free cross section of the picking chute 22. The first adjustable chute wall 26 has thus already been adjusted by way of its upper section 26a to the size of the first, relatively small pallet 32, whereas the lower section 26b is still adjusted to the dimensions of the large pallet 42 or the stack of load goods 14 on the pallet 42.

The second adjustable chute wall 28 and the opposite third adjustable chute wall, not shown, have likewise already been slightly adjusted in order to be able to receive the first, relatively small pallet 32. As will be explained in more detail, the second adjustable chute wall 28 and the opposite third adjustable chute wall are adjusted such that the distance between the second adjustable chute wall and the third adjustable chute wall increases. This is to accommodate the first, relatively small pallet 32, which is longer in a direction perpendicular to the drawing plane of FIG. 1 than the large second pallet 36 and the large third pallet 42.

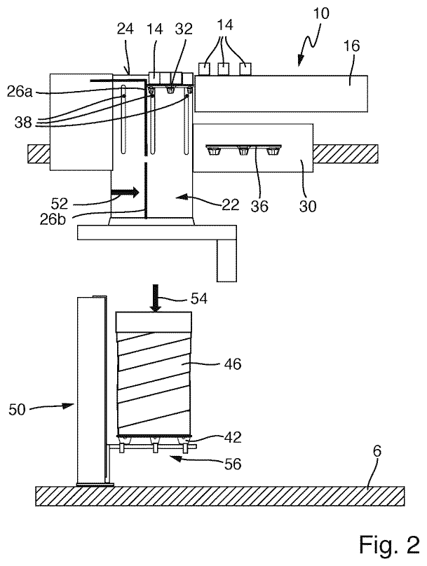

The state of FIG. 1 is followed by the state of FIG. 2 of the device 10. The picker 12 is no longer shown in FIG. 2 for reasons of clarity. In the state of FIG. 2, the picker 12 has however already arranged a first layer of load goods 14 on the first, relatively small pallet 32. The first pallet 32 can now be slightly lowered using the holding and moving means 38, which has already happened in the state of FIG. 2. The top side of the load goods stacked on the pallet 32 is thus already approximately level with the picking plane 24 and the picker 12 can stack a further load goods 14, which are delivered by means of the conveyor system 16, onto the first layer of load goods 14.

In the state of FIG. 2, the upper portion 26a of the first adjustable chute wall 26 is arranged unchanged such that it is arranged adjacent to the lateral boundary of the pallet 32. When pallet 32 is lowered, this ensures that load goods 14 cannot fall off the side of pallet 32. The lower section 26b of the first adjustable chute wall has been moved into the free cross section of the picking chute 22 in relation to the state of FIG. 1 according to arrow 52. The lower section 26b is aligned with the upper section 26a of the first adjustable chute wall 26 in the state of FIG. 2. The lower section 26b can be moved into the free cross section of the picking chute 22 in the state of FIG. 2 since the large third pallet 42 has already been completely wrapped with stretch film 46 and has been moved downwards in accordance with arrow 54 by means of the lifting and lowering device 50. Neither the third pallet 42 nor the stack of load goods on the third pallet 42 is/are thus still situated within the picking chute 22.

The lifting and lowering device 50 transfers the fully loaded pallet 42 to a conveyor system 56, only schematically illustrated, which ensures the fully loaded third pallet 42 is transported away.

The second pallet 36 is unchanged in its storage location in the temporary pallet store 30 in the state of FIG. 2.

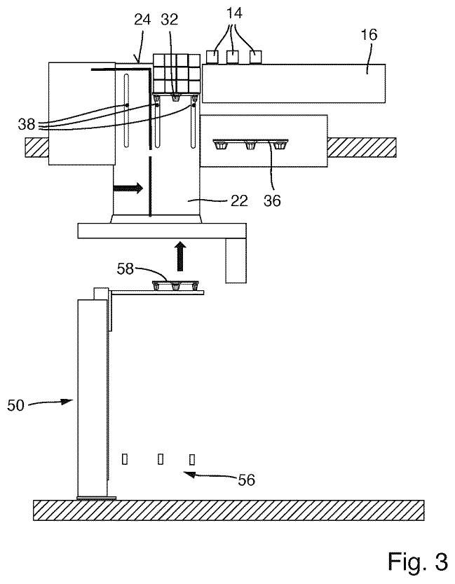

In the state of FIG. 3, the fully loaded third pallet 42 still shown in FIG. 2 has been transported and is therefore no longer shown. An unladen fourth pallet 58 has been delivered by means of the conveyor system 56 and already taken by the lifting and lowering device 50. In the state of FIG. 3, the fourth pallet 58 is already transported upwards in the direction of the lower end of the picking chute 22.

While the fourth unladen pallet 58 is transported upwards into the picking chute 22, the picker 12, not shown in FIG. 3, continues to load the first pallet 32 with load goods 14, which are transported to there by means of the conveyor device 16. In the state of FIG. 3, there are already three layers of load goods 14 on the first pallet 32. The first pallet 32 has been gradually lowered according to its loading state. Before the picker 12 stacks a further layer of load goods 14 onto the then topmost layer of load goods on the first pallet 32, this first pallet is further lowered by the holding and moving means 38 to such an extent that the top side of the topmost layer of load goods is then at or somewhat below the level of the picking plane 24.

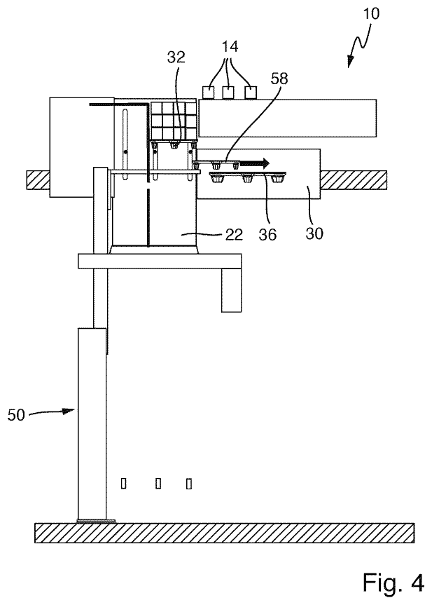

In the state of FIG. 4, the first pallet 32, as just described, has been slightly lowered, so that a further layer of load goods 14 can be stacked on. The lifting and lowering device 50 has introduced the fourth pallet 58 into the picking chute 22 from below at the level of the temporary pallet store 30. At the level of the second, upper storage location, the feed device, not illustrated, takes the fourth pallet 58 and moves it out of the free cross section of the picking chute 22 to the first storage location of the temporary pallet store 30. This movement takes place to the right according to the schematic illustration of FIG. 4. As soon as the fourth pallet 58 is completely arranged in the temporary pallet store 30 in its storage location, a small pallet and a large pallet, specifically the fourth pallet 58 and the second pallet 36, are available in the unladen state again in the temporary pallet store 30.

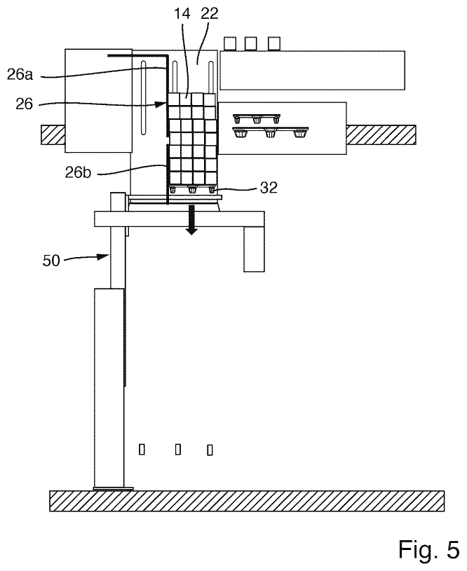

FIG. 5 shows a state of the device 10 that follows the state of FIG. 4. The first pallet 32 has been fully loaded and in the state of FIG. 5 has already been transferred to the lifting and lowering device 50 by the holding and moving means, not shown in FIG. 5. In the state of FIG. 5, the lifting and lowering device 50 has already lowered the fully loaded pallet 32 to such an extent that it is situated just ahead of the end of the picking chute 22. In the state of FIG. 5, the upper section 26a and the lower section 26b of the first adjustable chute wall 26 are unchanged in a position adjacent to the side edge of the first pallet 32 and adjacent to the stack of load goods 14 on the first pallet 32 respectively. This prevents load goods 14 on the pallet 32 from falling into the picking chute 22 from the side.

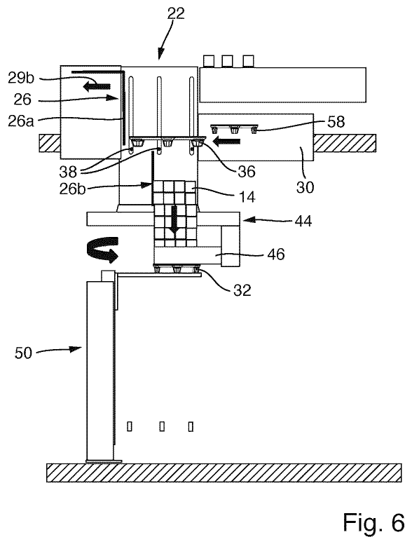

In the state of FIG. 6, which follows the state of FIG. 5, the first pallet 32 has already been lowered by means of the lifting and lowering device 50 to such an extent that the stack of load goods on the first pallet 32 can be wrapped with stretch film 46 in the wrapping station 44. The topmost layers of the stack of load goods 14 on the first pallet 32 are still held at the sides by the lower section 26b of the first adjustable chute wall and by the further chute walls of the picking chute 22. The topmost layer of load goods 14 on the first pallet 32 is already arranged below the vertical position of the temporary pallet store 30. From the temporary pallet store 30, the large second unladen pallet 36 can now be removed from the temporary pallet store 30 by means of the feed device, not shown, and transferred to the holding and moving means 38. As an alternative, the small fourth unladen pallet 58 could also be removed from the temporary pallet store 30 and transferred to the holding and moving means 38.

In order to be able to move the second, relatively large pallet 36 into the picking chute 22 at all, the upper section 26a of the first adjustable chute wall 26 has been moved out again in a direction in accordance with the arrow 25 from the free cross section of the picking chute 22, thus to the left in FIG. 6, in order to adapt the free cross section of the picking chute 22 to the dimensions of the second, relatively large pallet 36.

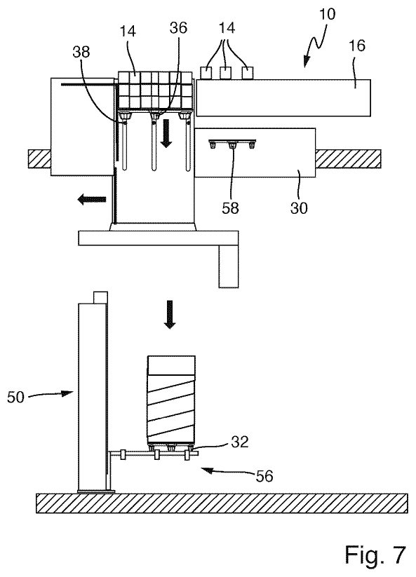

In the state of FIG. 7, which follows the state of FIG. 6, the second, relatively large pallet 36 is already loaded with load goods 14 by the picker 12, not shown, and gradually lowered by the holding and moving means 38 according to the number of layers on the pallet 36. In the state of FIG. 7, three layers of load goods 14 are already stacked on the second pallet 36. Following the state of FIG. 7, the holding and moving means 38 lower the second pallet 36 by the height of a layer of load goods 14, so that the picker can stack on further load goods 14.

As can be seen in FIG. 7, the second storage location in the temporary pallet store 30 is empty and only the small fourth pallet 58 is situated in the temporary pallet store 30.

In the state of FIG. 7, the first, fully loaded and wrapped pallet 32 is transferred straight from the lifting and lowering device 50 to the conveyor system 56.

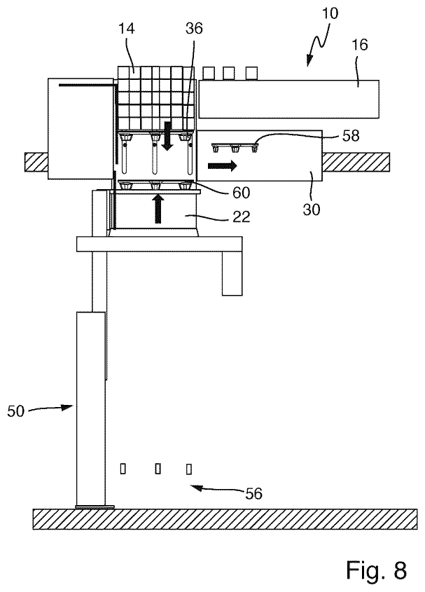

In the state of FIG. 8 of the device 10, which follows the state of FIG. 7, the fully loaded and wrapped first pallet 32 has already been transported away and is no longer shown. A fifth pallet 60 has been delivered via the conveyor system 56 and has already been moved into the picking chute 22 by the lifting and lowering device 50. The fifth pallet 60 is still situated just below the vertical position of the temporary pallet store 30, more precisely just below the vertical position of the second storage location in the temporary pallet store 30. Subsequently, in the state of FIG. 8, the fifth pallet 60 is still slightly lifted by means of the lifting and lowering device 50 to the vertical position of the second storage location in the temporary pallet store 30 and then taken by means of the feed device, not shown, and inserted into the temporary pallet store 30 to the right in FIG. 8.

As shown in FIG. 8, the second pallet 36 has been further loaded and in the state of FIG. 8 five layers of stacked load goods 14 are already situated on the second pallet 36.

When the fifth pallet 60 is situated in the temporary pallet store 30, the cross section of the picking chute 22 below the second pallet 36 is free, so that the second pallet can be further gradually lowered, transferred to the lifting and lowering device 50 and then wrapped with stretch film.

During the wrapping of the stack of load goods 14 on the second pallet 36, either the fourth pallet 58 or the fifth pallet 60 can then be removed from the temporary pallet store 30 and inserted into the picking chute 22 in order to then either load the fourth, small pallet 58 or the fifth, large pallet 60. The decision as to whether a small pallet or a large pallet is loaded is taken by a process computer, not shown, which also ensures that the load goods 14 intended for the respective pallet 14 are delivered via the conveyor system 16.

The device 10 according to the invention can also be used to load pallets of different sizes directly in succession. The device 10 according to the invention can thus be used in an extremely flexible manner.

FIG. 9 shows, as has already been stated, the device 10 according to a second embodiment. Instead of a picker 12, a picking robot 8 is provided in the device 10, the picking robot taking load goods 14 from the conveyor system 16 and positioning them on a pallet provided in the picking chute 22. As has been stated, a picking robot 12 can also operate in addition to the picking robot 8. However, the device 10 is otherwise operated by the picking robot 8 in the same way as has already been described with reference to FIGS. 1 to 8.

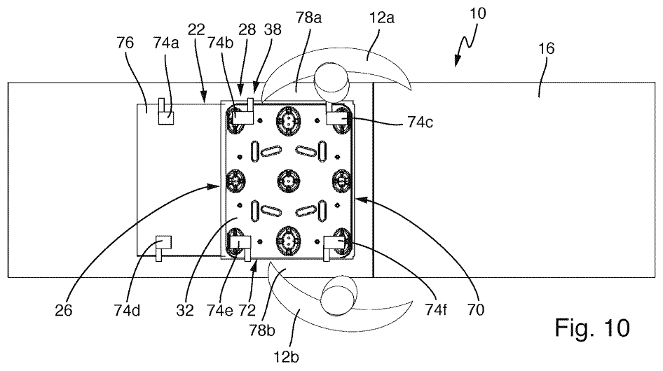

FIG. 10 shows a schematic plan view of the device 10. Two pickers 12a, 12b are schematically illustrated and are intended to take load goods, not shown in FIG. 10, from the conveyor system 16 and to move them to a pallet 32, the top side or loading area of which is arranged at the level of the picking plane. FIG. 10 shows the relatively small, first pallet 32. It can be seen in FIG. 10 that the first adjustable chute wall 26 has been moved into the free cross section of the picking chute 22 and is now arranged directly adjacent to the left-hand side edge of the pallet 32 in FIG. 10. A fourth, fixed chute wall 70, which is likewise arranged directly adjacent to the right-hand side edge of the pallet 32 in FIG. 10, is arranged opposite the first adjustable chute wall 26.

FIG. 10, at the top, shows the second adjustable chute wall 28, which has been moved slightly out of the free cross section of the picking chute 22. In the state of FIG. 10, the second adjustable chute wall is likewise arranged directly adjacent to the edge of the pallet 32 situated at the top in FIG. 10.

FIG. 10 now also shows the third adjustable chute wall 72, which is situated opposite the second adjustable chute wall 28. The third adjustable chute wall has likewise been moved slightly out of the free cross section of the picking chute 22 and is now arranged directly adjacent to the edge of the pallet 32 at the bottom in FIG. 10. The free cross section of the picking chute 22 has thus been adjusted to the size of the loading surface of the pallet 32 at the level of the picking plane, so that there is only a narrow circumferential gap between the outer contour of the loading surface of the small pallet 32 and the chute walls 26, 28, 70, 72.

It can be seen in the schematic plan view of FIG. 10 that the pickers 12a, 12b can now take load goods from the conveyor device 16 and place them on the pallet 32. Since the chute walls 26, 28, 70 and 72 of the picking chute 22 are arranged directly adjacent to the edges of the pallet 32, there is no need to worry about load goods falling off the pallet 32 and into the picking chute 22. The pickers 12 can even push load goods against one of the chute walls 26, 28, 70, 72 and use them as a stop when depositing load goods.

FIG. 10 schematically shows the means 38 for holding and moving the pallet 32. The means 38 have a total of six pallet supports 74a, 74b, 74c, 74d, 74e and 74f. In the plan view of FIG. 10, the pallet supports 74 themselves would not be visible since they are arranged below the pallet 32, but they are shown in FIG. 10 for clarification.

The pallet 32 rests, by way of its four feet, on the pallet supports 74b, 74c, 74e and 74f. As has been explained, the pallet supports 74b, 74c, 74e, 74f themselves would not be visible in the plan view of FIG. 10 since they are arranged below the pallet 32. The pallet supports 74a, 74d are not used in the state of FIG. 10 and would not themselves be visible either since they are arranged below a section 76 which is arranged horizontally and which is connected to the first adjustable chute wall 26.

It can be seen in FIG. 10 that a wall 78b between the picker 12b at the bottom in FIG. 10 and the pallet 32 as well as a wall 78a between the picker 12a at the top in FIG. 10 and the pallet 32 is very narrow. The two pickers 12 therefore only have to bend slightly over the walls 78a, 78b in order to move load goods from the conveyor system 16 to the pallet 32.

This is achieved in that the pallet supports 74a to 74f can be moved to an upper section of the picking chute 22, which extends from the standing surface 20 of the picking platform 18 to the picking plane 24, only in and counter to the vertical direction of the picking chute 22. The pallet supports 74a to 74f can be pivoted out or moved out of the free cross section of the picking chute 22 only below the standing surface 20 of the picking platform 18, this being described further below.

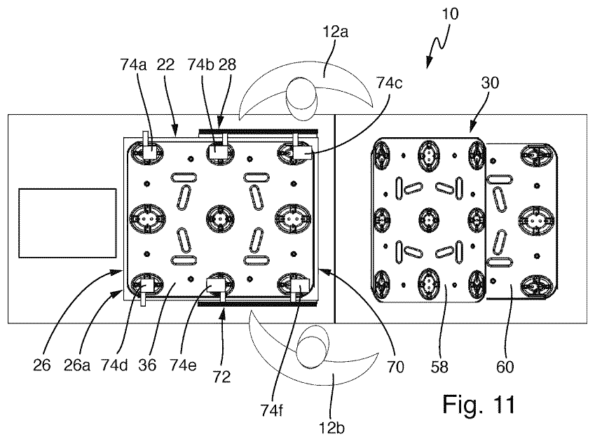

FIG. 11 shows a further schematic plan view of the device 10. In contrast to the state of FIG. 10, a second, relatively large pallet 36 is now arranged in the picking chute 22. In order to arrange the second, relatively large pallet 36 in the picking chute 22, cf. FIG. 6 and FIG. 7, the first adjustable chute wall 26, at least in the region of its upper section 26a, has been moved out of the free cross section of the picking chute 22. In the position of FIG. 11, the upper section 26a of the first adjustable chute wall 26 is arranged directly adjacent to the side edge of the pallet 36 on the left in FIG. 11.

Since the second, relatively large pallet 36 is wider than the first, relatively small pallet 32, in the state of FIG. 11 the second adjustable chute wall 28 and the third adjustable chute wall 72 have been moved slightly into the free cross section of the picking chute 22 in relation to the state of FIG. 10, so that in the state of FIG. 11 they are arranged directly adjacent to the edge of the pallet 36 at the top and, respectively, to the edge of the pallet 36 at the bottom in FIG. 11.

The fourth fixed chute wall 70 is likewise situated directly adjacent to the side edge of the pallet 36 on the right in FIG. 11. The free cross section of the picking chute 22 has thus been adjusted to the size of the loading surface of the pallet 36 at the level of the picking plane, so that there is only a narrow circumferential gap between the outer contour of the large pallet 36 and the chute walls 26, 28, 70, 72.

The pallet 36 rests by way of six of its feet in each case on one of the pallet supports 74a to 74f. Pallets with four feet, cross boards instead of feet or a circumferential frame instead of feet can also be loaded and moved within the scope of the invention. Only the shape and/or arrangement of the pallet supports has to be adjusted for this purpose. As has already been explained with reference to FIG. 10, the pallet supports 74a to 74f in the plan view of FIG. 11 themselves are not visible since they are arranged below the pallet 36, and have only been shown for clarification. The pallet supports 74a to 74f themselves in the plan view of FIG. 11 would be covered by the pallet 36.

The temporary pallet store 30, which itself is not visible in the plan view either, is shown in FIG. 11. Specifically, a small, fourth pallet 58 and a large, fifth pallet 60 are shown. The fourth, small pallet 58 is situated in the first storage location of the temporary pallet store 30, which is arranged above the second storage location in the temporary pallet store 30, with the fifth, large pallet 60 being situated in the second storage location.

Based on FIG. 11, it can be seen that the small pallets 58 and the large pallets 36, 60 do not have identical transverse dimensions. The small pallet 58 is narrower than the large pallet 60, but longer.

Picking on the small pallets 58 and the large pallets 36, 60 is made possible by the device 10 according to the invention in that the picking chute 22 is limited by three adjustable chute walls 26, 28, 72 and only one fixed chute wall 70.

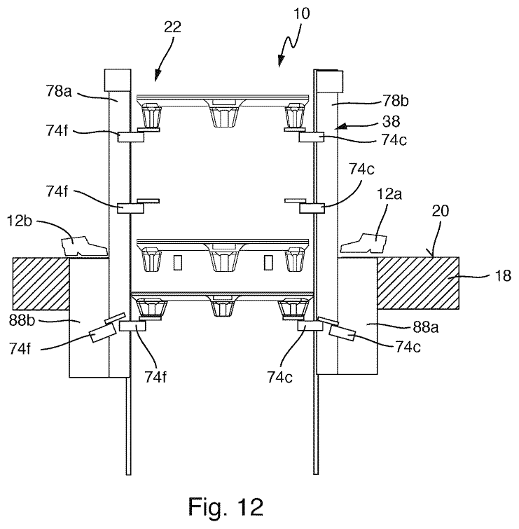

FIG. 12 shows a schematic sectional view of the device 10 of FIG. 1. The sectional plane in FIG. 12 runs parallel to the vertical direction of the picking chute 22, with the illustration of FIG. 12 being schematic.

FIG. 12 serves to illustrate the moving and holding means 38 and shows how the pallet supports 74a to 74f of the holding and moving means 38 are moved into and out of the free cross section of the picking chute 22.

FIG. 12 shows the picking platform 18, the top side of which forms the standing surface 20 for the pickers 12a, 12b shown only in the region of their feet in FIG. 12. It can be gathered from FIG. 12 that the pallet supports 74a to 74f, only two pallet supports 74c and 74f being shown in different states of movement in FIG. 12, can be moved out of the free cross section of the picking chute 22 below the standing surface 20. For this purpose, the pallet supports 74 are, for example, pivoted out along a curved path or, for example, even pivoted or tilted only around a rotation axis. In order to be able to carry out such a movement, a comparatively large amount of space is required on the side of the respective chute wall of the picking chute 22. This space is available below the standing surface 22 and, in FIG. 12, a cavity 88a, 88b is schematically drawn beneath the standing surface 20 for this purpose.

However, above the standing surface 20, the pallet supports 74a to 74f can be moved only in and counter to the vertical direction of the picking chute 22. This is shown by way of different positions of the two pallet supports 74c and 74f in FIG. 12. Only after the pallet supports 74a to 74f are arranged below the standing surface 20 again can they be pivoted away, tilted away or moved away in order to thereby clear the cross section of the picking chute 22 again. For this purpose, the pallet supports 74a to 74f are guided, for example, in sliding guides and are moved with a suitable drive system.

FIG. 12 thus shows several successive states at the same time in order to illustrate how the two pallet supports 74c, 74f are first moved into the free cross section of the picking chute 22 and then moved upwards to the upper end of the picking chute 22.

Since the pallet supports 74a to 74f above the standing surface 20 cannot be moved out of the free cross section of the picking chute 22, but can only be moved in and counter to the vertical direction of the picking chute 22, the walls 78a and 78b of the picking chute 22 can be very narrow. The two pickers 12a, 12b therefore do not have to bend far over the upper boundary of these two walls 78a, 78b in order to move the load goods onto a pallet arranged in the picking chute 22.

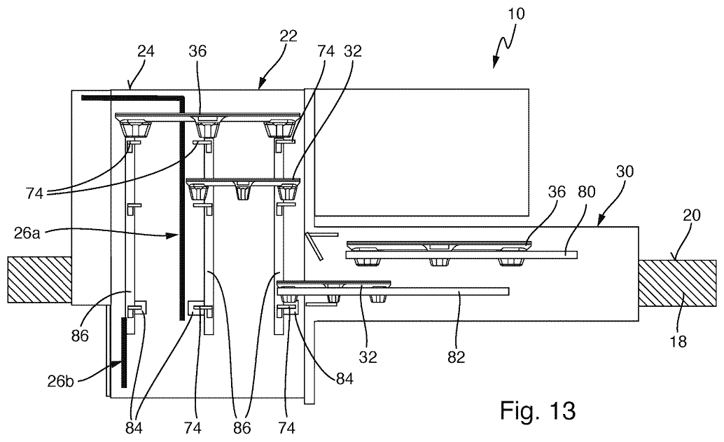

FIG. 13 shows a schematic sectional view of the device 10, where the sectional plane runs parallel to the vertical direction of the picking chute 22. However, the sectional plane in FIG. 13 is arranged perpendicular to the sectional plane of FIG. 12. As has been explained, the illustration of FIG. 13 is schematic. The picking platform 18 and the temporary pallet store 30 can be seen. The first storage location in the temporary pallet store 30 is occupied by a large pallet 36. This large pallet 36 is arranged in a holder 80 of the feed device. This holder can be moved in the horizontal direction, that is to say to the left in FIG. 13, into the picking chute 22 and back again. The holder 80 receives the feet of the pallet 36.

The second storage location in the temporary pallet store 30 is occupied by a small pallet 32. The pallet 32 is arranged in a second holder 82 of the feed device. The second holder 82 together with the pallet 32 can be moved to the left in a horizontal direction into the picking chute 22 and back again. In the state of FIG. 13, the second holder 82 has already been moved slightly into the picking chute 22.

Proceeding from the state of FIG. 13, the second holder 82 is moved further to the left into the picking chute 22, until the feet of the pallet 32 are arranged above the pallet supports 74. The pallet 32 can then be placed on the pallet supports 74 and the second holder 82 can be retracted again, so that it is moved out of the free cross section of the picking chute 22. For example, the pallet supports 74 lift the pallet 32 slightly, so that the holder 82 comes free from the pallet 32 and can be moved back into the pallet store 30.

By means of the pallet supports 74, the pallet 32 can then be moved upwards, this being schematically shown in FIG. 13.

FIG. 13 thus shows several successive states at the same time in order to illustrate the movement sequence.

The large pallet 36 would be retracted in the same manner by means of the first holder 80 into the free cross section of the picking chute 22 and there placed on the pallet supports 74 by way of its feet. The pallet 36 can then be moved in the picking chute 22 in the direction of the upper end of the picking chute 22, this being schematically shown in FIG. 13.

The upper section 26a of the first adjustable chute wall and the lower section 26b of the first adjustable chute wall 26 are likewise still drawn in FIG. 13. The upper section 26a has been moved into the free cross section of the picking chute 22 in the state of FIG. 13 in order to thereby adjust the free cross section of the picking chute 22 to the size of the loading surface of the small pallet 32, so that there is only a narrow gap on the side of the small pallet 32.

The lower section 26b, however, is shown in a retracted position, so that a large pallet 36 can be moved in the picking chute 22 to the level of the lower section 26b and inserted, for example, into the temporary pallet store 30, see the illustrations of FIGS. 8 and 9 in this respect.

FIG. 13 shows vertically arranged guides 86 for the pallet supports 74. The pallet supports 74 can be moved in and counter to the vertical direction of the picking chute 22 along these schematically illustrated guides 86. Openings 84 in the chute wall of the picking chute 22 are shown below the picking platform 18. The pallet supports 74 can be moved out, for example pivoted out, of the free cross section of the picking chute 22 through these openings 84.

In the state of FIG. 13, the small pallet 32 is removed from the temporary pallet store 30 and moved upwards up to just below the level of the picking plane 24 in order to be loaded there. The second storage location in the temporary pallet store 30 is then empty. A small pallet is then inserted into the temporary pallet store 30 again in order to fill the empty storage location and thus there is always a large pallet and a small pallet in the temporary pallet store 30. Depending on the requirements of a master computer, not shown, either a large pallet or a small pallet is then removed from the temporary pallet store and moved upwards to the level of the picking plane 24 for loading purposes.

During normal operation of the device 10, pallets to be loaded are always removed from the temporary pallet store 30. However, it is also possible to use the device 30 to lift an unladen pallet by means of the lifting and lowering device 50 and to transfer it directly to the holding and moving means 38 and then to move it to the level of the picking plane 24 for loading purposes.

### LIST OF REFERENCE SIGNS

6 Hall floor
8 Picking staff
10 Device
12 Pickers
14 Load goods
16 Conveyor device
18 Picking platform
20 Standing surface
22 Picking chute
24 Picking plane
26 First adjustable chute wall
26a Upper section of the first chute wall
26b Lower section of the first chute wall
28 Arrow
29 Arrow
30 Temporary pallet store
32 First pallet
34 Arrow
36 Second pallet
38 Moving and holding means
40 Arrow
42 Third pallet
44 Wrapping device
46 Stretch film
48 Arrow
50 Lifting and lowering device
52 Arrow
54 Arrow
56 Conveyor system
58 Fifth pallet
60 Sixth pallet
62 to 68 not assigned
70 Fourth chute wall
72 Third chute wall
74a to 74f Pallet support
76 Section
78a, 78b Walls of the picking chute
80 First holder of the feed device
82 Second holder of the feed device
84 Opening in the chute wall of the picking chute
86 Guides
88a, 88b Cavity

1. A device for picking on pallets or goods carriers, comprising:
a picking chute;
a temporary pallet store for unladen pallets, the temporary pallet store being arranged laterally next to the picking chute; and
a feed device for transporting an unladen pallet from the picking chute to the temporary pallet store or from the temporary pallet store to the picking chute;
the temporary pallet store has at least two storage locations for pallets of different sizes.

2. The device according to claim 1, wherein the at least two storage locations in the temporary pallet store are arranged one above the other in a vertical direction of the picking chute.

3. The device according to claim 1, further comprising a lifting and lowering device for moving an unladen pallet up to a level of the temporary pallet store.

4. The device according to claim 1, wherein the picking chute has at least one first adjustable chute wall, the first adjustable chute wall changing a free cross section of the picking chute at least in sections via a movement of the first adjustable chute wall perpendicular to a vertical direction of the picking chute, the first adjustable chute wall having an upper section and a lower section in the vertical direction of the picking chute, the upper section extending from a vertical position of the temporary pallet store to a picking plane at an upper end of the picking chute,
the lower section extending downwards starting from the vertical position of the temporary pallet store,
and the upper section and the lower section are adjustable independently of each other.

5. The device according to claim 4, wherein the upper section of the first adjustable chute wall is connected to a horizontally arranged section of the picking plane.

6. The device according to claim 4, further comprising at a second chute wall adjustable at least in sections, the second adjustable chute wall being arranged perpendicular to the first adjustable chute wall, the second adjustable chute wall changing a free cross section of the picking chute at least in sections via a movement of the second adjustable chute wall perpendicular to the vertical direction of the picking chute.

7. The device according to claim 6, further including a third chute wall adjustable at least in sections the third adjustable chute wall being arranged perpendicular to the first adjustable chute wall and changing a free cross section of the picking chute at least in sections via a movement of the third adjustable chute wall perpendicular to the vertical direction of the picking chute.

8. A picking device according to claim 1,
including means for holding and moving a pallet disposed in an upper section of the picking chute between a vertical position of the temporary pallet store and an upper end of the picking chute, the holding and moving means being designed and arranged to take an unladen pallet from the temporary pallet store using the feed device, to move the unladen pallet to the upper end of the picking chute and, during a start of at loading process, to gradually lower the pallet until the pallet is transferred from the holding and moving means to a lifting and lowering device,
the holding and moving means having several pallet supports movable into a free cross section of the picking chute and out of the free cross section, and the pallet supports are movable into the free cross section of the picking chute and out again below a standing surface for a picker or a picking robot.

9. The device according to claim 8, wherein the pallet supports are movable only in and counter to a vertical direction of the picking chute above the standing surface for the picker or the picking robot.

10. A method for picking on pallets or goods carriers with a device according to claim 1.
